(19) United States
(12) Patent Application Publication
(10) Pub. No.: US 2025/0237462 A1
(43) Pub. Date: Jul. 24, 2025

(54) INERT TRAINING RIFLE AND METHODS OF MANUFACTURING THE SAME USING ADDITIVE MANUFACTURING PROCESSES

(71) Applicant: PE3D, LLC, Carrolton, GA (US)

(72) Inventor: Nolan Childers, Carrolton, GA (US)

(21) Appl. No.: 18/625,502

(22) Filed: Apr. 3, 2024

Related U.S. Application Data
(63) Continuation-in-part of application No. 18/420,949, filed on Jan. 24, 2024.

(51) Int. Cl. F41A 33/00; B33Y 80/00; F41G 3/26

(52) U.S. Cl. CPC F41A 33/00; F41G 3/26; B33Y 80/00

(57) ABSTRACT

Described herein are examples of a 3D training firearm and methods for manufacturing the same. In an example, the training firearm comprises a core rod and one or more 3D printed components having a central bore for receiving a portion of the core rod. Each of the 3D printed components can resemble a portion of a live firearm though, in some embodiments, the components can be comprised of a material having a color indicative of an inert training device. At least two of the one or more 3D printed components can be formed such that a distal end of one can be coupled to a proximal end of the other and, once coupled, the two components cannot rotate about the core rod with respect to one another. One or more of the printed components can further include structure for attaching a functional component associated with a live firearm.

### RELATED APPLICATIONS

This application is a continuation-in-part of and claims priority to U.S. patent application Ser. No. 18/420,949, titled “Inert Training Firearms and Methods of Manufacturing the Same Using Additive Manufacturing Processes,” filed Jan. 24, 2024, which is incorporated in its entirety by reference for all purposes.

### BACKGROUND

Additive manufacturing, more commonly known as 3D printing, is an approach to manufacturing objects by constructing such objects layer by layer from digital 3D models. In contrast to a traditional subtractive manufacturing process, which may involve cutting, machining, or otherwise removing material from a larger piece to achieve the desired shape, additive manufacturing builds up the final product incrementally.

The process typically begins with the creation of a digital 3D model using computer-aided design (CAD) software. This digital representation serves as a virtual blueprint for the physical object. The next step involves slicing the 3D model into thin, horizontal layers using specialized software. Each of these layers represents a cross-sectional slice of the final object.

Once the model is sliced, the 3D printer reads the data and proceeds to manufacture the object layer by layer. The choice of materials can vary and includes plastics, metals, ceramics, and even biological materials, depending on the specific 3D printing technology used. Common 3D printing technologies include fused deposition modeling (FDM), stereolithography (SLA), selective laser sintering (SLS), and more.

As each layer is deposited, it undergoes a process to ensure proper adhesion and structural integrity. This may involve curing, fusing, or solidifying the material, depending on the specific printing technology. The layering process continues until the entire physical object is produced.

The application of additive manufacturing spans various industries. For example, additive manufacturing can be used to create training firearms. Training firearms are imitation firearms specifically designed for educational and training purposes. These replicas closely mimic the size, weight, and handling characteristics of real firearms, providing a safe environment for individuals to practice and learn without the risks associated with live weapons. For example, training firearms are often used in scenario-based training exercises to simulate real-life situations and enhance decision-making skills. As a result, training firearms are used in various fields, including law enforcement, military, security, and civilian firearm safety courses.

Training firearms are designed to closely resemble actual firearms, both in terms of external appearance and weight. This realism contributes to a more authentic training experience. However, training firearms are incapable of firing live ammunition. They lack functional firing mechanisms, ensuring that they cannot discharge bullets.

One type of training firearm is sometimes referred to as a “non-gun replica.” Non-gun replicas are typically made from materials like rubber or plastic and they are completely inert and have no moving parts. As used herein, the terms “training firearm” and “non-gun replica” may be used interchangeably.

As a safety measure and to avoid confusion with functional firearms, 3D printed training firearms are typically printed using bright colored (e.g., blue, orange, or red) material that clearly identifies the inert training firearm as a training aid and ensures the training tools are not confused with live weapons. However, 3D printed training firearms can also have drawbacks. For example, by altering the color of 3D printed training firearms, a degree of realism is lacking in the user experience that can negatively influence a user's training. Additionally, they can be structurally weaker compared to live firearms composed of metal such as aluminum. As a result, some 3D printed training firearms can break or crack when used in training exercises that simulate real world scenarios involving physical activity such as running, climbing, crawling, rappelling, or jumping, for example.

As a result, a need exists for 3D printed training firearms, and methods for producing the same, that are not only visually distinct from a live firearm but provide the user or trainee with a realistic training experience and are structurally robust and resistant to breaking or degrading when used in training exercises.

### SUMMARY

Descriptions herein include examples of 3D printed inert training firearms for use in training law enforcement, military personnel, and civilian hobbyists, for example. For purposes of this disclosure, 3D printing and additive manufacturing may be used interchangeably. Further, as used herein, “training firearm” or “training rifle” should be interpreted as an inert or non-functional/non-firing training device that shares some visual and/or physical similarities with a live or functional firearm but is designed for use in firearm training exercises. It should further be understood that while one or more embodiments set forth in this disclosure and the figures may include training “rifles,” the products and processes described herein apply to all types of training firearms, including but not limited to handguns and shotguns.

In an example, a 3D printed training firearm can include a core rod and a plurality of 3D printed components. In some embodiments, one or more of the plurality of 3D printed components resemble a portion of a live firearm and comprise a central bore for receiving a portion of the core rod. In further embodiments, at least one of the 3D printed components comprise a portion suitable for attaching at least one functional component suitable for use with a live firearm. In one aspect, the 3D printed components can include a receiver portion, a handguard portion, a stock coupler portion, a suppressor portion, and/or an accessory rail portion. In another aspect, the functional component can be one or more of a functional stock or telescopic sight. In some examples, the functional stock can couple to the stock coupler. In further or alternative examples, the telescopic sight can couple to the accessory rail portion.

In another aspect, one or more of the 3D printed components can be comprised of a material having a color indicative of an inert or non-functional training firearm. In some examples, the color of the material can be blue, red, orange, chartreuse, or some other bright color that provides clear indicia to a training participant and/or any bystanders that the training firearm is inert and non-functional (i.e., incapable of firing a projectile).

In a further aspect, at least two of the 3D printed components comprise corresponding ends configured for coupling to one another. In some examples, the corresponding ends are shaped such that, once coupled, the two 3D printed components cannot rotate with respect to one another.

A method is also provided for providing a 3D print file for making a training firearm using an additive manufacturing process. The method can include providing one or more computer-aided design (“CAD”) drawings, each drawing comprising one or more 3D objects resembling a portion of a live firearm of a make and model. Each 3D object can further comprise a central bore extending along at least a portion of the length of the 3D object.

In one aspect, the CAD drawing can be edited such that a first of the 3D objects comprises at one of its ends a portion for receiving a corresponding portion of a second of the 3D objects after the objects are printed. In some embodiments, the first and second objects can be coupled such that they cannot rotate with respect to one another.

In another aspect, the method can include editing at least one of the 3D objects such that it is configured for coupling to a functional component suitable for use with a live firearm. In some embodiments, the functional component can include a functional stock and/or a functional telescopic sight.

In a further aspect, the one or more CAD drawings, or derivatives thereof (e.g., a G-code print file) can be provided to one or more users for printing using a 3D printer. In some embodiments, the 3D objects can be printed using a material providing indicia that the 3D objects are inert or otherwise non-functional components of a training device.

Both the foregoing general description and the following detailed description are exemplary and explanatory only and are not restrictive of the examples, as claimed.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is an illustration of an exploded view of example training firearm components;

FIG. 2 is an illustration of an assembled view of example training firearm components;

FIG. 3 is an illustration of front and rear views of example training firearm components;

FIG. 4 is an illustration of front and rear views of example training firearm components; and

FIG. 5 is a flow chart depicting steps in an example additive manufacturing process for printing training firearm components.

### DESCRIPTION OF THE EXAMPLES

Reference will now be made in detail to the present examples, including examples illustrated in the accompanying drawings. Wherever possible, the same reference numbers will be used throughout the drawings to refer to the same or like parts.

Described herein are examples of a 3D printed inert training firearm for training purposes, as well as method of manufacturing the same. In one aspect, the additive manufacturing of 3D printed training firearms involves a careful design and material selection process to ensure realism, durability, and compliance with all applicable legal requirements. For example, the design of a training firearm should closely approximate the size, weight, and ergonomics of the live or actual firearm it is intended to simulate. This would include elements of the training firearm such as its grip, trigger, barrel, and overall shape. However, whether required by law or for safety purposes, training firearms can be designed with clear indicators that they are inert, non-functional, and incapable of firing live ammunition. In some embodiments, this can involve incorporating permanently visible features to signal that the firearm cannot be used as a live weapon or to fire ammunition. For example, to prevent confusion with real firearms, training firearms can be printed using bright colored materials to clearly identify them as a training tool. Printing the training firearm with non-moving and/or non-functional components can further emphasize the inert nature of the object.

In another aspect, the material chosen for 3D printing should be durable enough to withstand handling during training exercises and not susceptible to one or more components breaking or failing in the course of use or when mishandled by an inexperienced trainee. In some examples, materials used to 3D print training firearms are high-strength plastics like ABS or nylon. In some embodiments, the printing material can comprise TPU 98A for some or all components of the training firearm, which can be considered a strong, flexible, abrasion resistant material. In a further aspect, the weight of a training firearm as well as the distribution of weight along its body should be as close to the actual firearm as possible. In some examples, particular materials may be used, added, or omitted from areas within the printed object to yield a training firearm with a life-like feel and weight distribution.

In further aspects, training firearms can be 3D printed using a 3D printer and a print file. In some examples, the print file can be G-code generated from a computer-aided design (“CAD”) drawing of an inert training firearm, such as an inert training pistol. The CAD drawing can be created by one or more authors based on the dimensions of an actual firearm that the training firearm is intended to emulate. For example, the author(s) can use CAD software to construct the 3D geometry of the training firearm by drawing shapes, extruding and revolving the shapes, and using other tools to form the desired structure. In some embodiments, all dimensions, angles, and other physical parameters of the training firearm rendering can be adjusted until the 3D object closely resembles an actual firearm of a specific make and model. In alternative embodiments, a user can access one or more databases that store reference 3D CAD files associated with training firearms, each associated with a specific make and model of an actual firearm.

Regardless of the method by which a 3D CAD drawing for a training firearm is created or otherwise obtained, a user can use CAD software to alter the shape of the 3D object to remove, subtract, trim, cut, or otherwise edit one or more features of the 3D object. In some examples, a user may desire to remove one or more features of the 3D object in order to facilitate the future substitution of features of the training firearm with features more closely resembling real or live firearms. For example, in the case of a training rifle, the user can remove the rifle's front or rear sights or the rifle's stock and replace them with components that more closely resemble the components of a live rifle that the training rifle is seeking to emulate. In some embodiments, for example, the stock of the training rifle can be omitted from the 3D object and the printed rifle can be coupled with a telescoping stock typically used with in conjunction with a live rifle. In alternative or further embodiments, the front and rear sights can be omitted from the 3D printed object and front and rear sights that closely resemble the sights of a live rifle can be coupled to the training rifle. Or, in other embodiments, a fully functional telescopic sight can be coupled to the training rifle.

Such substitutions can result in a more life-like training experience for a user training with the 3D printed inert firearm. For example, when the user aims the training rifle at a target by either aligning the rifle's sights with the target or viewing the target through a functional telescopic lens, the user perceives a sight picture that more closely resembles that of a live rifle. Similarly, in embodiments where the training rifle is coupled to a functional telescoping stock, the user can adjust the length of the stock on the training rifle to emulate a live rifle that has been configured by the user.

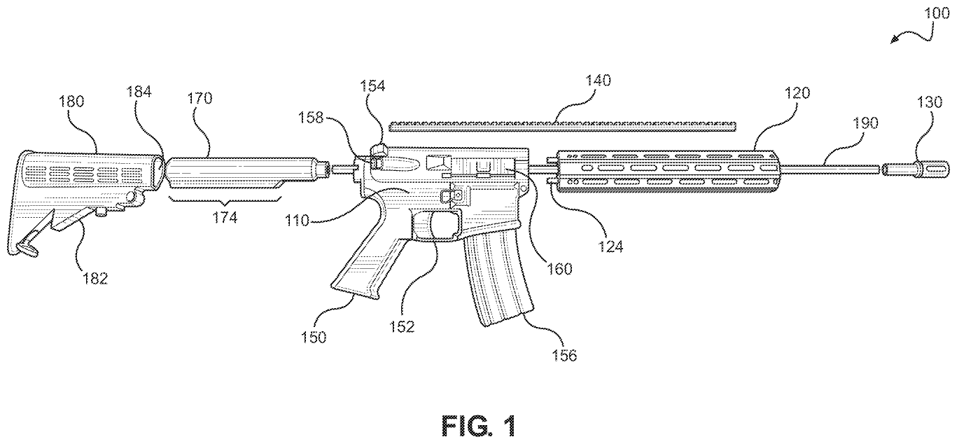

FIG. 1 is an illustration of an exploded perspective view of an example training firearm 100 for use in training law enforcement or military personnel or other individuals. In one aspect, one or more components of training firearm 100 can be 3D printed using a print file such as a G-code file, for example. In some embodiments, 3D printed components of training firearm 100 can be composed of a plastic material such as ABS or nylon. In further embodiments, the material for printing components of training firearm 100 can be selected, in part, based on its color. For example, components of training firearm 100 can be printed using a bright colored material, such as blue, orange, or red material. In such embodiments, the color of training firearm 100 components can provide a clear visual indication that the object is a training tool and not a real or live (i.e., functioning) firearm capable of firing a projectile.

In one aspect, training firearm 100 can mimic the appearance of a live firearm of a particular make and model, exhibiting many of the same physical features, albeit with components that do not function. For example, training firearm 100 can be approximately the same size, shape, or weight of a semi-automatic rifle such as, for example, an AR-15. In another aspect, training firearm 100 can comprise 3D printed components including, for example, a receiver 110 (i.e., an integral, non-functioning combination of an upper receiver and a lower receiver), a handguard 120, a flash suppressor 130, and an accessory rail 140. In further embodiments, receiver 110 is comprised of a plurality of non-moving, non-functioning features including a grip 150, a trigger portion 152, a charging handle 154, a magazine 156, a forward assist 158, and an ejection port 160.

In another aspect, one or more portions of training firearm 100 can be omitted relative to a live firearm of a particular make and model. For example, rather than printing a stock component, an elongate stock coupler 170 can be 3D printed that couples at its distal end to receiver 110 and adjustably couples at its proximal end and along a portion of its length to a live or functioning stock 180 (e.g., a telescoping stock). For purposes of this disclosure, the “distal” end of an object refers to the end of an object closer to the muzzle end of training firearm 100 depicted in FIG. 1. The “proximal” end of an object refers to the end of the object closer to the stock end of training firearm 100.

In other embodiments, front and/or rear sights can be omitted from training firearm 100. In such embodiments, live or functioning sights and/or a telescopic sight (not depicted) can be mounted to the 3D training rifle along rail 140. Alternative, 3D printed sights can be produced and mounted along rail 140.

In a further aspect, a core rod 190 can be provided on which one or more of receiver 110, handguard 120, suppressor 130, and stock coupler 170 can be mounted. In some embodiments, core rod 190 can be comprised of a metal such as steel or aluminum. Alternatively, core rod 190 can comprise any material suitable for providing additional strength to a fully assembled training firearm 100, regardless of whether core rod 190 is 3D printed or produced using another manufacturing method.

In another aspect, receiver 110 and handguard 120 can comprise a bore or hole 112, 122, respectively (not depicted in FIG. 1), extending along their entire length from their proximal end to their distal end. In some examples, bores 112 and 122 can be of a cross-sectional size and shape suitable to mate with (i.e., substantially match) the cross-sectional size and shape of core rod 190. In this way, during assembly, core rod 190 can be passed through receiver 110 and handguard 120. In further embodiments, once mounted on core rod 190, receiver 110 can be coupled to handguard 120 using a pair of pins 124 that can be positioned within corresponding recesses 114 (located in a distal end of receiver 110, not depicted in FIG. 1) and 126 (located in a proximal end of handguard 130, not depicted in FIG. 1). For example, recesses 114 of receiver 110 and recesses 126 of handguard 120 can be formed during the 3D printing of receiver 110 and handguard 120. Pins 124 can also be 3D printed in some embodiments. Alternatively, pins 124 can be comprised of metal or some other material of suitable strength and size. In further examples, recesses 114 and 126 can be defined, in terms of their cross-sectional shape, to substantially correspond to (i.e., approximately match) the cross-sectional shape of pins 124.

During assembly, in some embodiments, a distal end of pins 124 can be placed in recesses 126 of handguard 120 and, as handguard 120 and receiver 110 are mounted on rod 190, a proximal end of pins 124 can be positioned in recesses 114 of receiver 110. In use, pins 124 can provide additional strength to training firearm 100 and prevent receiver 110 and handguard 120 from rotating about rod 190 with respect to one another.

In embodiments in which pins 124 are 3D printed, pins 124 can be printed layer-by-layer with each layer lying in a plane extending along the longitudinal extension of the pins (i.e., in a direction extending generally from stock 170 of training firearm 100 to suppressor 130 of firearm 100). In this way, any sheer force acting either perpendicular to the longitudinal extension of firearm 100, or acting in some direction other than the longitudinal extension of firearm 100, is applied in a direction that is “against the grain” of the printed layers of pins 124. As a result, pins 124 can provide additional strength to training firearm 100 and reduce the risk of firearm 100 breaking, or receiver 110 and handguard 120 being able to rotate with respect to one another, during a training session.

In another aspect, suppressor 130 can comprise a bore or hole 132 (not depicted in FIG. 1) extending from its proximal end and terminating at a location along its length in the distal direction. In some examples, like bores 112 and 122, bore 132 of suppressor 130 can be of a cross-sectional size and shape suitable to mate with (i.e., substantially match) the cross-sectional size and shape of core rod 190. Because bore 132 terminates at some location along the length of suppressor 130, however, suppressor 130 can only be slid a predetermined distance onto the distal end of core rod 190 rather than allowing core rod 190 to pass through suppressor 130, as can be the case with receiver 110 and handguard 120. During assembly, in some examples therefore, suppressor 130 can act as a “cap” for maintaining receiver 110 and handguard 120 on core rod 190.

Similarly, in a further aspect, stock coupler 170 can comprise a bore or hole 172 (not depicted in FIG. 1) extending from its distal end and terminating at a location along its length in the proximal direction. In some examples, bore 172 of stock coupler 170 can be of a cross-sectional size and shape suitable to mate with (i.e., substantially match) the cross-sectional size and shape of core rod 190. Because bore 172 terminates at some location along the length of stock coupler 170, however, stock coupler 170 can only be slid a predetermined distance onto the proximal end of core rod 190 rather than allowing core rod 190 to pass through stock coupler 170, as can be the case with receiver 110 and handguard 120. During assembly, in some examples therefore, stock coupler 170 can act as an opposing “cap,” opposite suppressor 130, for maintaining receiver 110 and handguard 120 on core rod 190.

In another aspect, where a stock is omitted from the 3D printed components, live or functional stock 180 can be provided. In some examples, stock 180 can be any suitable stock for use with training firearm 100. In further examples, stock 180 can closely resemble and/or be identical to the stock found on whichever firearm that training firearm 100 seeks to mimic. As shown in FIG. 1, stock 180 can be a functional telescoping stock in some examples, complete with an adjustment lever 182 for adjusting the position of stock 180 along the length of stock coupler 170. In one illustrative embodiment, stock 180 comprises a bore 184 extending from its distal end and terminating at a location along its length in the proximal direction or extending its entire length and terminating at its proximal end.

In such embodiments, bore 184 of stock 180 can be of a cross-sectional size and shape suitable to mate with (i.e., substantially match) the cross-sectional size and shape of stock coupler 170. In further embodiments, stock coupler can comprise a series of recesses 174 (not depicted in FIG. 1) on its lower surface. Pressing adjustment lever 182 of stock 180 can, in some examples, extract an otherwise spring-urged pin located inside stock 180 such that stock 180 can be positioned elsewhere along the length of stock coupler 170. Releasing adjustment lever 182 can then, in such embodiments, allow the internal, spring-urged pin to engage a corresponding recess on stock coupler 170 to secure stock 180 in a preferred position for the user/trainee.

In another aspect, one or more of receiver 110, handguard 120, suppressor 130, and stock coupler 170 can be secured to core rod 190 in any suitable way. For example, a glue or epoxy can be applied to the outside of core rod 190 prior to mounting the one or more components onto the rod. Additionally or alternatively, the corresponding cross-sectional shape of core rod 190 and each bore in the respective component can serve to pressure-fit the components on rod 190. In still other embodiments, one or more 3D printed components can be heated prior to mounting them on core rod 190 such that they can be melt bonded to rod 190 as the rod passes through the component's respective bore.

In a further aspect of training firearm 100, accessory rail 140 can be coupled to the upper surface of receiver 110 and/or handguard 120 after receiver 110 and handguard 120 are coupled to one another. In one embodiment, accessory rail can include a series of recesses along its length such that one or more screws can be positioned within the recesses from the rail's upper surface and screwed into one or more threaded inserts or recesses located in the upper surface of receiver 110 and/or handguard 120. Once secured, in some examples, rail 140 can extend along some portion of training firearm 100's length.

In another aspect, accessory rail 140 can comprise a series of ridges along its length that mimic ridges found on a functional rail of a live firearm. In this way, rail 140 can provide structure for mounting one or more functional accessories otherwise suitable for mounting on a live firearm. For example, functional front and rear sights can be mounted to rail 140. In alternative examples, 3D printed front and rear sights that comprise a material intended to mimic functional sights (e.g., a black or metallic looking material) can be provided for mounting to rail 140. In still other examples, a functional telescopic sight (i.e., a “scope”) can be mounted to rail 140. In each case, it should be noted, a user of training firearm 100 can be afforded a more realistic, life-like sight picture compared to using a fully integral 3D printed training device comprised of a brightly colored material or otherwise exhibiting visual indicators of the device's inert nature.

In further embodiments, one or more additional accessory rails 140 can be mounted in a similar fashion along the underside of handguard 120 and/or along one or both sides of handguard 120. In some embodiments, these additional rails 140 can be used to mount additional functional accessories that can be otherwise suitable for use with a live firearm. For example, a functional tri-pod component, supplemental grip component, and/or flashlight component can be mounted to training firearm 100. In this way, a trainee can configure training firearm 100 to mimic the configuration of the live firearm they intend to use in the field.

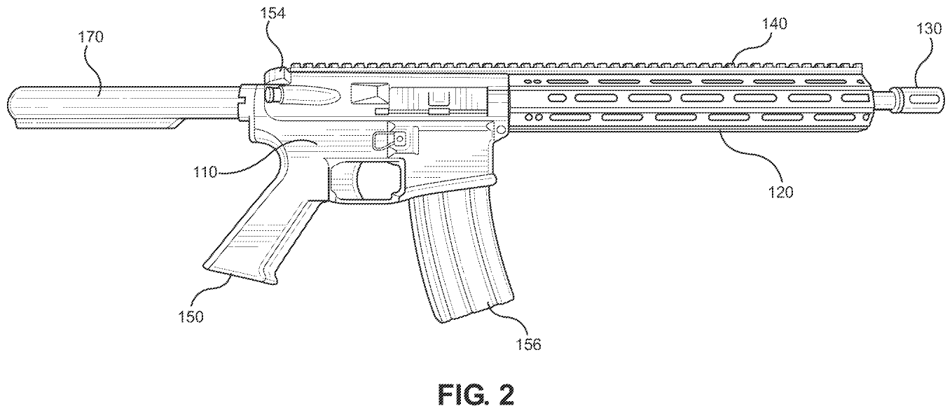

FIG. 2 depicts an illustrative embodiment of training firearm 100 after assembling receiver 110, handguard 120, suppressor 130, accessory rail 140, and stock coupler 170. In one aspect, one or more of such components are 3D printed. In some examples, a material can be selected that affords training firearm 100 sufficient strength and robustness to withstand impacts related to training exercises. In further examples, brightly colored printing material (e.g., blue, red, orange, or chartreuse) can be used to provide a clear visual indicator to those participating in a training exercise and/or bystanders that training firearm 100 is an inert device incapable of firing a projectile.

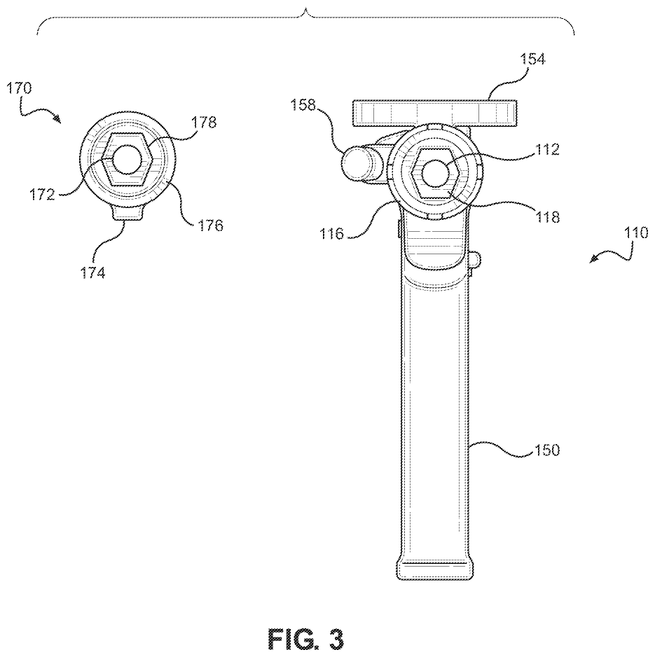

In another aspect, a proximal end of core rod 190 can be positioned within bore 172 of stock coupler 170, as described previously. The distal end of rod 190 can then be passed through bore 112 of receiver 110 starting from the receiver's proximal end, in some examples. In this way, receiver 110 can be slid the length of rod 190 in the proximal direction until a distal end of stock coupler 170 abuts or is otherwise coupled to the proximal end of receiver 110. Further details regarding the coupling between stock coupler 170 and receiver 110 are provided with respect to FIG. 3.

In another aspect, handguard 120 can be mounted to rod 190 in a similar fashion as that described with respect to receiver 110. Handguard 120 can be slid the length of rod 190 in the proximal direction until a distal end of receiver 110 abuts or is otherwise coupled to the proximal end of handguard 120. In some embodiments, the coupling between receiver 110 and handguard 120 can be accomplished by aligning one or more recesses in the distal end of receiver 110 with corresponding recesses in the proximal end of handguard 120, and positioning a proximal end of pins 124 within the recesses of receiver 110 and a distal end of pins 124 within the recesses of handguard 120.

In a further aspect, suppressor 130 can then be mounted to rod 190 such that, in some examples, the distal end of rod 190 is inserted into bore 132 of suppressor 130 until the proximal end of suppressor 130 abuts or is otherwise coupled to the distal end of handguard 120.

In yet another aspect, accessory rail 140 can then be coupled to the upper surface of receiver 110 and/or handguard 120 to facilitate the attachment of one or more accessories including but not limited to front and rear sights, a scope, a flashlight, a tripod, or a supplemental grip. In some examples, one or more of these accessories can be functional components that are otherwise suitable for use on a live firearm. In further or alternative embodiments, one or more such accessories can be 3D printed using a material selected in order to closely approximate a functional accessory (e.g., using a black material or material of particular weight and design). In either case, more life-like accessories such as sights or a scope can afford a user of training firearm 100 with a more realistic training experience and sight picture.

Though no stock is shown in FIG. 2, it should be appreciated that a functional stock (e.g., telescoping stock suitable for use on a live firearm) or a fixed or 3D printed stock can be coupled to stock coupler 170. This coupling can be accomplished in any suitable manner including but not limited to the manner described above with respect to FIG. 1. Like the accessories mentioned above, one advantage to using a functional stock is that a user of training firearm 100 can configure the stock length of the training device to match or closely match the stock length of a live firearm that the user intends to use.

While the previous description of assembling receiver 110, handguard 120, suppressor 130, accessory rail 140, stock coupler 170, stock 180, and core rod 190 may be presented as an illustrative series of steps, one of skill in the art will understand that any particular order of steps presented here is only illustrative and these steps can be performed in any suitable order and/or one or more steps can be performed simultaneously or in overlapping fashion with any other step.

FIG. 3 depicts a front view of stock coupler 170 (i.e., from its distal end) and a rear view of receiver 110 (i.e., from its proximal end). During assembly of training firearm 100, in some embodiments, the proximal end of core rod 190 can be positioned within bore 172 and stock coupler 170. In further examples, the distal end of core rod can be placed in bore 112 of receiver 110 at its proximal end and receiver 110 can be slid along the length of core rod 190 until the proximal end of receiver 110 abuts the distal end of stock coupler 170.

FIG. 3 further depicts one illustrative embodiment in which the proximal end of receiver 110 can be coupled to the distal end of stock coupler 170. In one aspect, as the distal end of stock coupler 170 comes in contact with the proximal end of receiver 110, an outer surface 176 of stock coupler 170 can be sized such that it fits inside a recess 116 at the proximal end of receiver 110. In another aspect, the distal end of stock coupler can comprise a protrusion 178 of some shape comprising substantially flat sides. As depicted in FIG. 3, the cross-sectional shape of protrusion 178 can be hexagonal (i.e., having six sides of substantially equal length), in one example. As outer surface 176 of stock coupler 170 is positioned in recess 116 of receiver 110, protrusion 178 can be positioned within a secondary recess 118 of receiver 110 that can be located within larger recess 116, in some examples. The cross-sectional shape of secondary recess 118 can correspond to the cross-sectional shape of protrusion 178 such that secondary recess 118 can receive protrusion 178. In one aspect, the mating of protrusion 178 within secondary recess 118 can not only aid in coupling stock coupler 170 to receiver 110, but because the cross-sectional shape of protrusion 178 and secondary recess 118 comprise one or more flat sides, the protrusion and secondary recess can facilitate a proper alignment (in a rotational direction about core rod 190) between stock coupler 170 and receiver 110. Further, in some embodiments, the protrusion and secondary recess can serve to prevent stock coupler 170 and receiver 110 from rotating about core rod 190 with respect to one another.

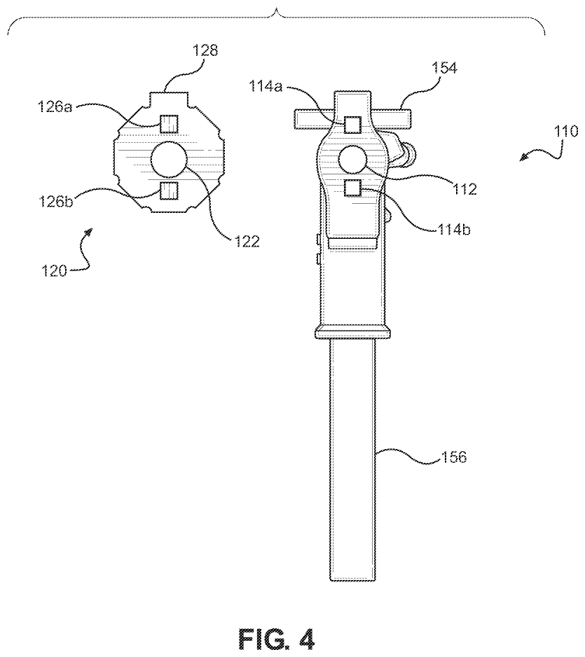

FIG. 4 depicts an illustrative embodiment in which the distal end of receiver 110 can be coupled to the proximal end of handguard 120. In one aspect, the distal end of receiver 110 can include one or more recesses 114a, 114b. Similarly, the proximal end of handguard 120 can include one or more corresponding recesses 126a, 126b of similar size and cross-sectional shape. In some embodiments, receiver 110 and handguard 120 can be mounted on core rod 190 by positioning the core rod through bore 112 of receiver 110 and bore 122 of handguard 120. As the proximal end of handguard 120 comes in contact with the distal end of receiver 110, as further described with respect to FIG. 1, one or both of receiver 110 and handguard 120 can be rotated such that their corresponding recesses can be substantially aligned with one another.

In another aspect, a pin 124 (not depicted in FIG. 4) can be positioned in each of the recesses of receiver 110 or handguard 120. For example, as shown in FIG. 1, the distal end of pins 124 can be positioned in recesses 126a, 126b of handguard 120. In such embodiments, as receiver 110 and handguard 120 are brought in contact with one another, the proximal end of pins 124 can be positioned in recesses 114a, 114b of receiver 110. In this way, pins 124 can serve to couple receiver 110 to handguard 120, and prevent receiver 110 and handguard 120 from rotating about core rod 190 with respect to one another.

In some examples, such as the embodiment depicted in FIG. 4, recesses 114a, 114b, 126a, and 126b can have a substantially square cross-sectional shape. In such embodiments, pins 124 can comprise a corresponding cross-sectional shape of similar size such that each of the pins' ends can be pressure fit in the recesses of receiver 110 and handguard 120. Of course, this is only one possible example of the cross-sectional shape of recesses 114a, 114b, 126a, and 126b and pins 124. Any suitable shape can be used including circular or hexagonal cross-sectional shapes. Further, in addition to pressure-fitting pins 124 in recesses 114a, 114b, 126a, and 126b, the pins can be secured within the recesses using epoxy, a melt bond, or any other suitable means.

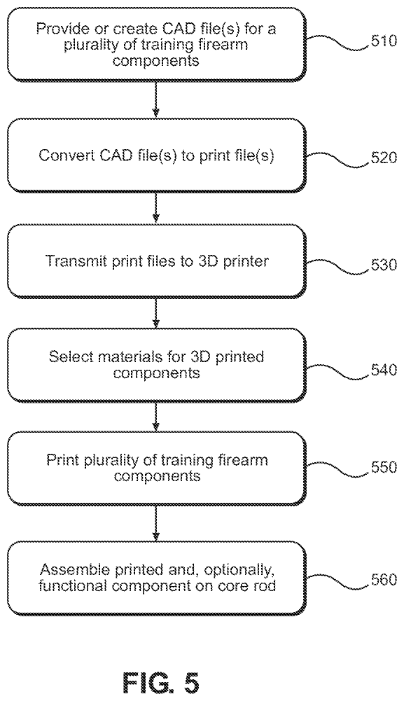

FIG. 5 depicts a flowchart including example steps in a process for manufacturing training firearm 100, in some embodiments. In step 510, a user of a computer (who could be but is not necessarily a user of training firearm 100) can obtain one or more CAD drawings of components comprising training firearm 100. In some examples, the components closely resemble the appearance of corresponding live firearm components of a particular make and model. In some embodiments, the user can create the components using a CAD program. In other embodiments, the user can retrieve existing drawings of components from one or more databases.

At step 520, the user can convert the CAD drawings of the training firearm components to G-code files for use by a 3D printer. The G-code can contain, among other information, instructions for printing the firearm object, front sight, and rear sight in a layer-by-layer process. While “G-code” is used herein to describe a file type executable by a 3D printer, one of ordinary skill in the art understands that any appropriate file type that is executable by a 3D printer could be used. In alternative embodiments, the method illustrated in FIG. 5 can commence at step 520 rather than 510. In other words, rather than the user creating or obtaining one or more CAD files comprising drawings of training firearm components and then converting those drawings to print or G-code files, the user can initiate the method of constructing the training firearm by obtaining the print or G-code files from a source such as one or more databases, in some examples.

At step 530, in some embodiments, the user can transmit the one or more G-code print files for the firearm components to a 3D printer for printing. In some examples, the user's computer can be connected directly to the 3D printer. In other examples, the user can transmit the print files over a wired or wireless connection to the 3D printer or to a server for storage. In such embodiments, the 3D printer and/or server can be in the same geographical location of the user's computer or one or both of the printer and server can be remotely located.

At step 540, in one aspect, the user can select a suitable material for printing one or more of the training firearm components. In some embodiments, the training firearm components can include a receiver 110, a handguard 120, a suppressor 130, an accessory rail 140, and a stock 180 and/or stock coupler 170. In further embodiments, the user can select one or more high-strength plastics or composites like ABS or nylon, or some other suitable material for printing the components. In further embodiments, the user can also select a color for the material that is appropriate for a training firearm. For example, the user can select a brightly colored material (e.g., blue, orange, red, or chartreuse) such that the printed training firearm components will be clearly distinguishable from a live firearm even at a great distance or in poor visibility conditions.

In another aspect, the user can select one or more additional materials for printing one or more additional training firearm components. For example, additional components such as front and rear sights can be printed using one or more high-strength plastics like ABS or nylon. Alternatively, these components can be printed using one or more metals, composites, or other suitable materials. Unlike the components printed using a material having a bright color indicative of a training device, however, the user can select a material and color for these training firearm components that closely resembles the material and color of corresponding components of a live firearm which training firearm 100 seeks to mimic. In such embodiments, for example, the front and rear sights of the training firearm, once assembled, can provide a trainee with a more realistic user experience and life-like sight picture. In other embodiments, rather than front or rear sights, other additional components can be printed using a material and color that more closely resembles a live firearm.

At step 550, each of the training firearm components (whether printed using material providing a visual indication of a training device or material more closely resembling a live firearm) can be printed at a 3D printer. As described above, the 3D printer can be local or remote with respect to the user, in some examples. In further examples, the print files for the plurality of training firearm components can be sent to a plurality of 3D printers, each printer for printing one or more of the components. In some embodiments, for example, the user can print the receiver 110, the handguard 120, the suppressor 130, the accessory rail 140, and the stock coupler 170 across one or more 3D printers.

At step 560, in one aspect, a core rod 190 can be provided on which each of the 3D printed training firearm components can be mounted or otherwise assembled. For example, a core rod 190 can be provided and its proximal end can be positioned in a central bore of stock coupler 170. Receiver 110, handguard 120, and suppressor 130 can also be mounted on core rod 190 by passing the rod through the central bore of each of those components and the components can all be arranged on core rod 190 such that the distal end of stock coupler 170 is coupled to (or otherwise in contact with) the proximal end of receiver 110, the distal end of receiver 110 is coupled to (or otherwise in contact with) the proximal end of handguard 120, and the distal end of handguard 120 is coupled to (or otherwise in contact with) the proximal end of suppressor 130, in some examples. In further embodiments, accessory rail 140 can then be coupled to an upper surface of receiver 110 and/or handguard 120.

In another aspect, one or more functional components otherwise suitable for use with a live firearm can be provided and coupled to the training firearm assembly. For example, a functional scope, front and rear sights, and/or a stock (e.g., a telescoping stock) can be provided. In the case of a scope or front and rear sights, these functional components can be coupled to the training firearm assembly at accessory rail 140 in a way and location corresponding to how and where the functional components would be coupled to a live firearm. Similarly, in the case of a functional stock, the stock can be coupled to stock coupler 170 in a way and location corresponding to how and where the functional stock would be coupled to a live firearm.

Other examples of the disclosure will be apparent to those skilled in the art from consideration of the specification and practice of the examples disclosed herein. Though some of the described methods have been presented as a series of steps, it should be appreciated that one or more steps can occur simultaneously, in an overlapping fashion, or in a different order. The order of steps presented is only illustrative of the possibilities and those steps can be executed or performed in any suitable fashion. Moreover, the various features of the examples described here are not mutually exclusive. Rather any feature of any example described here can be incorporated into any other suitable example. Further, with respect to FIG. 5, while one or more steps may be performed by a “user,” it is understood that the described steps need not all be performed by a single individual or machine. Rather, any one or more steps could be completed by a first individual or machine, and any one or more remaining steps could be completed by one or more other individuals or machines. Additionally, “user” in the context of obtaining, creating, or editing CAD drawings and/or G-code print files are not necessarily the same “users” as those who use the training firearm for firearm training purposes, though they could be. It is intended that the specification and examples be considered as illustrative only, with a true scope and spirit of the disclosure being indicated by the following claims.

What is claimed is:

1. A 3D printed training firearm, comprising:
one or more 3D printed components each having a central bore, each 3D printed component corresponding to a portion of a live firearm;
a core rod configured to pass at least partially through the central bore of each 3D printed component;
one or more functional components otherwise suitable for use in connection with a live firearm, the functional components configured for coupling to at least one of the 3D printed components.

2. The 3D printed training firearm of claim 1, wherein the 3D printed components include two or more of a receiver portion, a handguard portion, a stock coupler portion, and a suppressor portion.

3. The 3D printed training firearm of claim 2, further comprising an accessory rail portion configured for coupling to an upper surface of the receiver portion or the handguard portion.

4. The 3D printed training firearm of claim 1, the one or more 3D printed components comprising a material having a color indicative of an inert or non-functional training firearm.

5. The 3D printed training firearm of claim 1, wherein at least two of the 3D printed components are mounted on the core rod and coupled to one another such that the at least two 3D components cannot rotate about the axis of the core rod with respect to one another.

6. The 3D printed training firearm of claim 1, wherein the one or more 3D printed components are secured to the core rod by applying an epoxy to the core rod or melt bonding each of the 3D printed components to the core rod.

7. The 3D printed training firearm of claim 1, wherein the one or more functional components comprise a stock or a telescopic sight.

8. A 3D printed training firearm, the training firearm comprising:
a core rod;
a plurality of 3D printed components, one or more of the plurality of 3D printed components having a central bore for receiving a portion of the core rod, each 3D printed component resembling a portion of a live firearm,
wherein one or more of the 3D printed components comprises a portion suitable for attaching at least one functional component suitable for use with a live firearm.

9. The 3D printed training firearm of claim 8, wherein the plurality of 3D printed components comprise a 3D printed accessory rail for mounting to a surface of another of the plurality of 3D printed components.

10. The 3D printed training firearm of claim 9, wherein the accessory rail is configured for coupling to a functional telescopic sight.

11. The 3D printed training firearm of claim 8, wherein one of the 3D printed components is configured for coupling to a functional stock.

12. The 3D printed training firearm of claim 8, wherein a first of the plurality of 3D printed components is comprised of a material having a color indicative of an inert or non-functional training firearm.

13. The 3D printed training firearm of claim 12, wherein the color is blue, red, orange, or chartreuse.

14. The 3D printed training firearm of claim 8, wherein a second of the plurality of 3D printed components is comprised of a second material having a color resembling the color of components of the live firearm.

15. A method for creating a 3D print file for making a training firearm using an additive manufacturing process, comprising:
providing one or more computer-aided design (“CAD”) drawings, each drawing of a three-dimensional (“3D”) object resembling a portion of a live firearm and having a central bore extending along at least a portion of the 3D object;
editing a first and second of the 3D objects such that the first of the 3D objects comprises at one of its ends a portion for receiving a corresponding portion of the second of the 3D objects such that when the first and second 3D objects are printed and coupled to one another they cannot rotate with respect to one another;
editing one or more of the 3D objects such that the one or more of the 3D objects is configured to coupling to a functional component suitable for use with the live firearm; and
providing the one or more CAD drawings, or derivatives thereof, to a user for 3D printing.

16. The method of claim 15, wherein the one or more 3D objects include two or more of a receiver portion, a handguard portion, a stock coupler portion, and a suppressor portion.

17. The method of claim 15, further comprising providing a CAD drawing comprising an accessory rail portion.

18. The method of claim 17, further comprising editing the CAD drawing of the accessory rail portion to include one or more apertures along a length of the accessory rail portion.

19. The method of claim 15, wherein the derivative of the one or more CAD drawings is a 3D print file.

20. The method of claim 19, wherein the 3D print file is a G-code print file.
